(19) United States
(12) Patent Application Publication
(10) Pub. No.: US 2022/0106176 A1
(43) Pub. Date: Apr. 7, 2022

(54) COMBINED BOTTLE OPENING AND BEVERAGE PRESERVATION DEVICE AND METHOD

(71) Applicants: Rachel M. Spencer, Port St. John, FL (US); Stacey B. Spencer, Melbourne Beach, FL (US)

(72) Inventors: Rachel M. Spencer, Port St. John, FL (US); Stacey B. Spencer, Melbourne Beach, FL (US)

(21) Appl. No.: 17/165,203

(22) Filed: Feb. 2, 2021

Related U.S. Application Data
(60) Provisional application No. 63/088,513, filed on Oct. 7, 2020.

(51) Int. Cl. B67B 7/08

(52) U.S. Cl. CPC B67B 7/08

(57) ABSTRACT

A combined bottle opening and beverage preservation device and method is shown which provides a battery powered device that includes a non-coring needle that may be inserted through the cork/stopped or a bottle to transfer compressed air into the bottle which causes the cork/stopper to be expelled from the bottle. The same device may also be used to remove air from the bottle to preserve the remaining beverage contained in a bottle.

### FIELD OF THE INVENTION

The present invention relates to bottle opening devices and methods. More particularly, the present invention relates to an electrically powered bottle opening and beverage preservation device and method for use with bottles that are sealed by a stopper or cork or the like. In addition, the bottle opening device and method also provides a means to reseal the bottle and preserve the liquid inside the bottle.

### BACKGROUND OF THE INVENTION

Cork, (Gk. phellos), is a compressible wood having low water absorption derived from the meristern bark of live oaks. It has been known to be in use since 400 BC. Cork has been used to close bottles, and in particular wine bottles, since the 1600's. The elastically compressible nature of cork, coupled with its low absorption of water, make it ideally suited as a closure material, because it conforms to openings, even those having a somewhat irregular shape, forming a water tight seal.

Cork is still in use today by wine vintners, in part because of its historically proven successful performance, and also because it embodies the public's perception of the bottling method of choice, especially for finer wines. A certain savoir faire is often associated with the opening of a bottle of wine, and a variety of uncorking devices have been developed to assist in the presentation. The uncorking task is complicated by the nature of the cork material. While cork is elastically compressible, it is also somewhat friable, and is subject to crumbling when dry or exposed to excessive force. Being a natural product there is also an inherent degree of nonhomogeneity. The cumulative effect of these factors has resulted in a plethora of uncorking devices. Most of the more recent inventions use a worm-like helical “shaftless” corkscrews to minimize the over-all expansion of the cork when the corkscrews is inserted. Expansion is undesirable as it increases the radial force on the perimeter of the cork against the interior wall of the neck of the bottle, making the cork harder to extract. The older type of corkscrews is the auger “shaft” type corkscrews The inserted “shaft” tends to expand the cork outwards, making uncorking more difficult. Rydgren U.S. Pat. No. 5,031,486 discusses this effect. Note, that both types of corkscrews have a very low thread count with a high degree of pitch and a wide flight so as to distribute the twisting action through out the cork, therein reducing the probability of the cork crumbling.

Mechanized corkscrew and in particular electric corkscrews have been described in the prior art, as a means of automating the uncorking process. Manual uncorking using a corkscrew is not particularly physically rigorous, however it does require a repetitious twisting action, which can become difficult after several bottles. The twisting action can be extremely painful for someone with arthritis, or carpal tunnel syndrome. Mechanized corkscrews alleviate the twisting action, and all but eliminate the physical effort, however, generally, with coincident deleterious effects on the cork. For instance, Spencer U.S. Pat. No. 5,079,975 discloses an automatic corkscrew wherein the force of the rotating corkscrew extracts the cork into the “extraction tube”. During the extraction, the corkscrew penetrates through the base of the cork, which can result in cork grinds being conveyed into the bottle. Secondly, the torque required to extract the cork is on the order of 2-3 times the torque required to twist the corkscrew into the cork, reaching a peak torque just prior to the cork yielding to the extraction forces. Twisting the corkscrew into the cork requires only approximately 1 Newton-meter, however to pull the cork out using a corkscrew with a 45 degree pitch (1.4 mechanical advantage) varies depending on the percent of compression and nature of the cork, but is generally on the order of 2.5-3.5 Newton-meters. This level of torque would create a pulling force of 26 to 38 Kg on the cork. This is sufficient force to cause considerable grinding action on the cork by the rotating corkscrew hence the coincident deleterious effects on the cork.

Another consideration, particularly for battery powered corkscrew as disclosed in Spencer U.S. Pat. No. 5,079,975, is that the readily available commercial drivers have only a finite amount of dynamic torque. The dynamic torque, while being more than adequate for twisting in the corkscrew is, without gear reduction modification or a much more expensive driver, marginal at the peak torque demand during the cork extraction. The problem of marginal torque is further exacerbated wherein it is desirous to extract the cork without previously removing the packaging seal. It should be noted that in serving large parties of people, where one is most likely to employ an electric corkscrew, the packaging seal is frequently not removed, because it takes as much time to take it off as it does to uncork the bottle.

Thus, there is a long-felt need to develop a new type of bottle opener device that is simple to use, aesthetically pleasing, and minimizes the damage to the cork or stopper. There is also a further need for a bottle opener device that is battery powered and is easily rechargeable for continued use.

It is therefore an object of the invention to provide an easy to use, aesthetically pleasing electrically powered bottle opening and beverage preservation device and method that can be easily and quickly inserted into the cork or stopper of a bottle and with the press of a button, remove the cork or stopper from the bottle and also be used for removing air from the bottle for beverage preservation.

### BRIEF DESCRIPTION OF THE DRAWINGS

Embodiments will be described with reference to the following drawing figures, in which like numerals represent like items throughout the figures, and in which:

FIG. 1 is a front plan view of a bottle opening and beverage preservation device in accordance with an exemplary embodiment of the invention.

FIG. 2 is an isometric view of a bottle opening and beverage preservation device in accordance with an exemplary embodiment of the invention.

FIG. 3 is an isometric cut-away view of a bottle opening and beverage preservation device in accordance with an exemplary embodiment of the invention.

FIG. 4 is an isometric cut-away view of a bottle opening and beverage preservation device in accordance with an exemplary embodiment of the invention.

FIG. 5 is a simplified section view of the air compressor assembly in accordance with an exemplary embodiment of the invention.

FIG. 6 is an isometric view of a bottle opening and beverage preservation device inserted into a cork/stopper of a bottle in accordance with an exemplary embodiment of the invention.

FIG. 7 is an isometric view of a bottle opening and beverage preservation device in a position to seal the bottle and remove air from the bottle to preserve the liquid in the bottle.

FIG. 8 is a simplified schematic showing the air compressor components of the bottle opening and beverage preservation device in accordance with an exemplary embodiment of the invention.

### DETAILED DESCRIPTION

The present invention is described with reference to the attached figures. The figures are not drawn to scale and they are provided merely to illustrate the invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

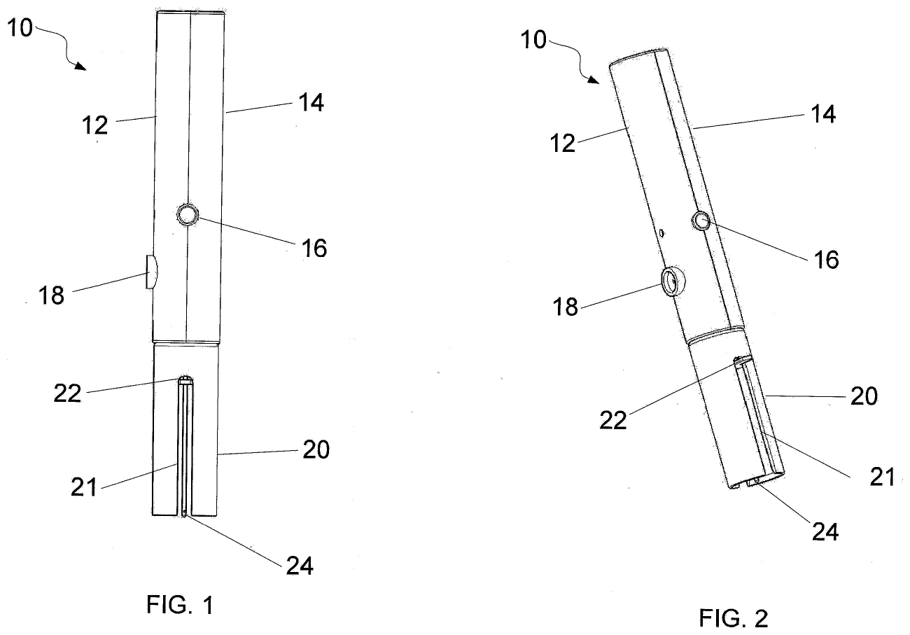

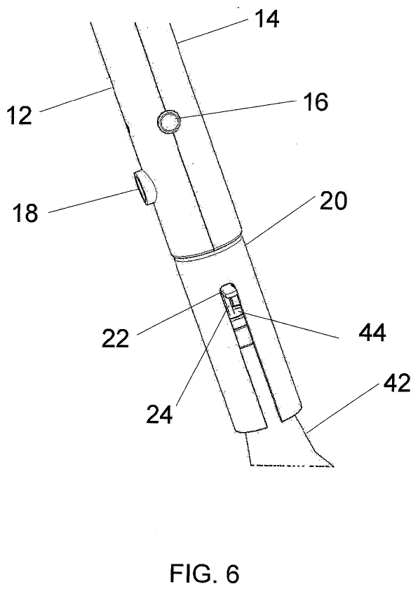

Referring now to FIGS. 1-8, where like numerals indicate like features, an exemplary electrically powered bottle opening and beverage preservation device 10 is shown. Referring first to FIGS. 1, 2 and 6, a left housing 12 is affixed to a right housing 14 and an electrical switch 16 is disposed on the surface of the device 10. An air inlet 18 is also located on the surface of the device 10. Affixed to a bottom distal end of the device 10 is a cylindrically shaped guide 20. A non-coring needle 24 extends longitudinally from the bottom distal end of the device 10 and the needle 24 is located concentrically to the guide 20. The needle 24 is configured to pierce the cork/stopper of the bottle 42 and extend past the cork/stopper 44 into the internal volume of a bottle. The guide 20 is configured to fit around the neck area of the bottle 42 and help guide the needle's 24 insertion into the cork/stopper 44 of the bottle that is to be opened. A pair of diametrically opposed slots 21 run down the guide 20 and a slide 22 is disposed in the slots 21. The slide 22 is configured to move up and down the length of the needle 24 to remove a cork/stopper that is attached to the needle 24 when the cork is removed from the bottle.

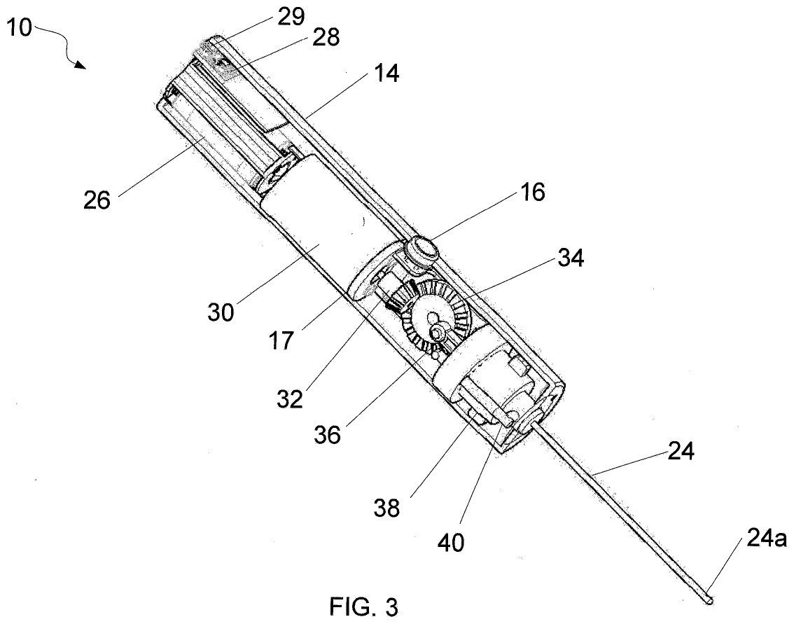

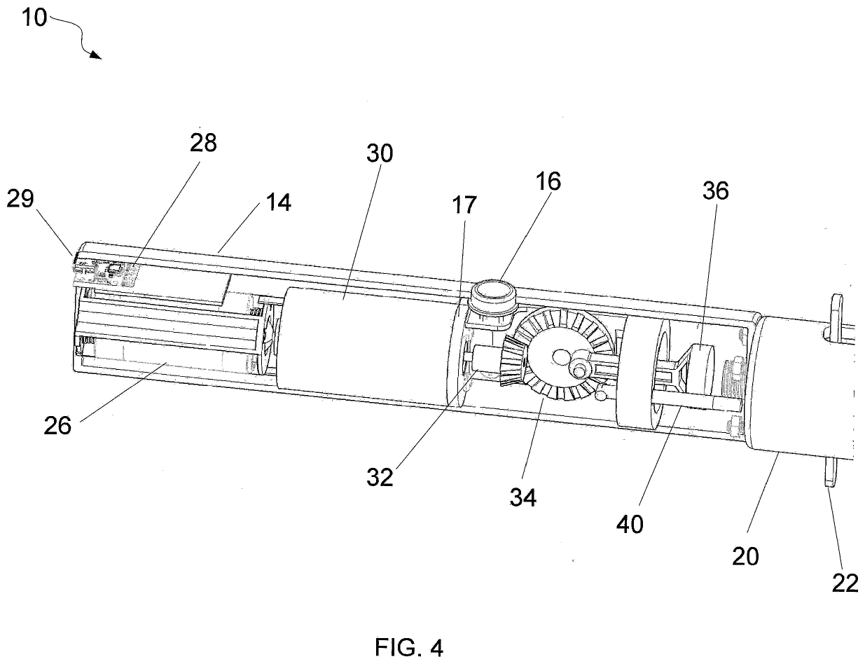

Referring now to FIGS. 3 and 4, the internal components of the device 10 will now be described. FIG. 3 has the guide 20 removed for clarity. Located at a top distal end of the device 10 is a charging connector 29 which is configured to accept an electrical connection in order to recharge a battery pack 26. A charging circuit 28 is disposed near the connector 29 and the battery pack 26, the charging circuit is configured to safely and reliably recharge the battery pack 26 in any well known manner. An electrical motor 30 is disposed in the device 10. The electric motor 30 is powered by the battery pack 26 and the electrical switch 16 is configured to turn the motor 30 on and off as required by the user. In a preferred embodiment, the motor 30 is a 12 volt direct current motor but any suitable motor will work.

A motor gear 32 is rigidly affixed to the shaft of the motor 30 and is configured to mesh with a piston gear 34. The motor gear 32 may be a bevel gear that meshes with a bevel piston gear 34. The piston gear 34 is rotatably affixed to a frame 17. The frame 17 may be configured to be rigidly affixed to the motor 30 and the right housing 14. Affixed to the piston gear 34 is a piston 36. The piston 36 is affixed to the piston gear 32 so that it moves in a back and forth motion as the piston gear 34 rotates. The piston 36 translates back and forth in a compressor cylinder 38. Compressor cylinder 38 has been removed from FIG. 4 to more clearly show the location of the piston 36.

The piston 36 creates a positive pressure, the pressure stroke, as it is forced forward in the compressor cylinder 38 by the rotation of the piston gear 32. This positive pressure of air is transferred through the needle 24 and out of the orifice 24a into the internal volume of the bottle that is to be opened. As more and more pressurized air is transferred through the needle 24 into the internal volume of the bottle, the internal pressure in the bottle increases rapidly. The increased internal pressure in the bottle will act to force the cork/stopper out of the bottle. Through experimentation it has been found that most corks/stoppers will release from the bottle when an internal pressure in the bottle is between 30-55 psi. An air inlet passageway 40 is provided adjacent the compressor cylinder 38. The inlet passageway 40 is configured to communicate air from the air inlet 18 to the compressor cylinder 38.

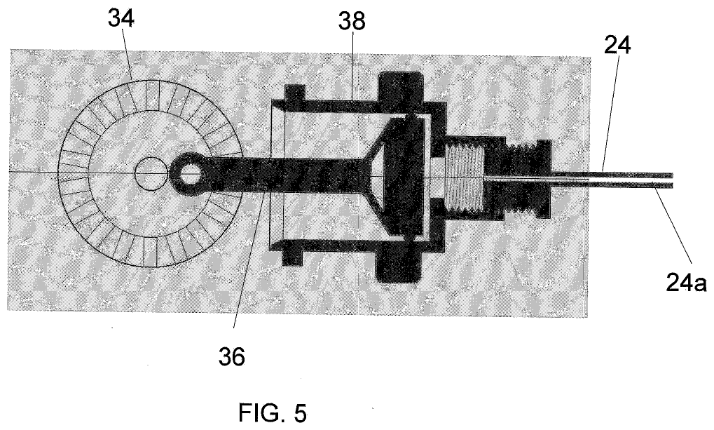

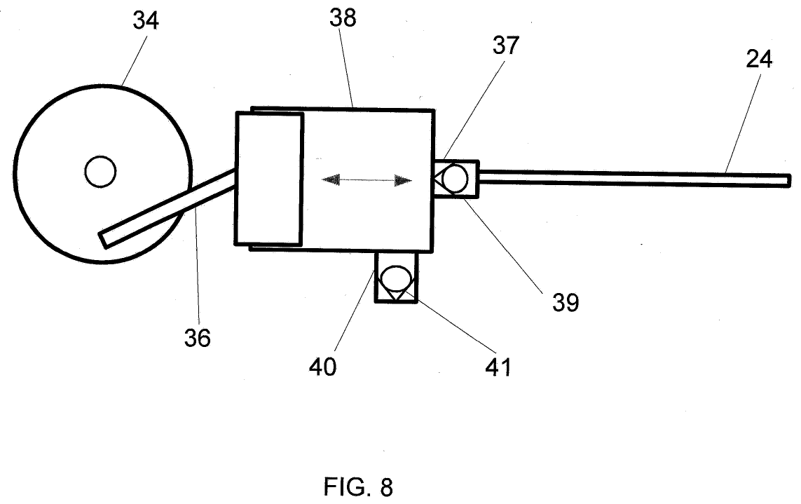

Referring now to FIGS. 5 and 8, which shows a simplified view of the air compressor components, a needle check valve 39 (FIG. 8) is disposed in the compressor cylinder near the inlet to the needle 24, in any well known manner, to direct the pressurized air into the bottle during the pressure stroke. The needle check valve 39 is also configured to prevent air from being drawn out of the bottle when the piston is drawn backward in the compressor cylinder 38. In this manner, air may only travel into the bottle through the air outlet 37 (FIG. 8). An inlet check valve 41 (FIG. 8) is also disposed in the compressor cylinder 38 adjacent to an air inlet 40. The inlet check valve 41 is configured to prevent the compressed air from traveling into the air inlet 40 during the compression cycle but allows air into the compressor cylinder 38 when the piston 36 is retracted. In this manner, ambient air is drawn into the compressor cylinder 38 when the piston 36 is retracted and the compressed air is forced into the needle 24 through the air outlet 37 and hence into the bottle during the pressure stroke.

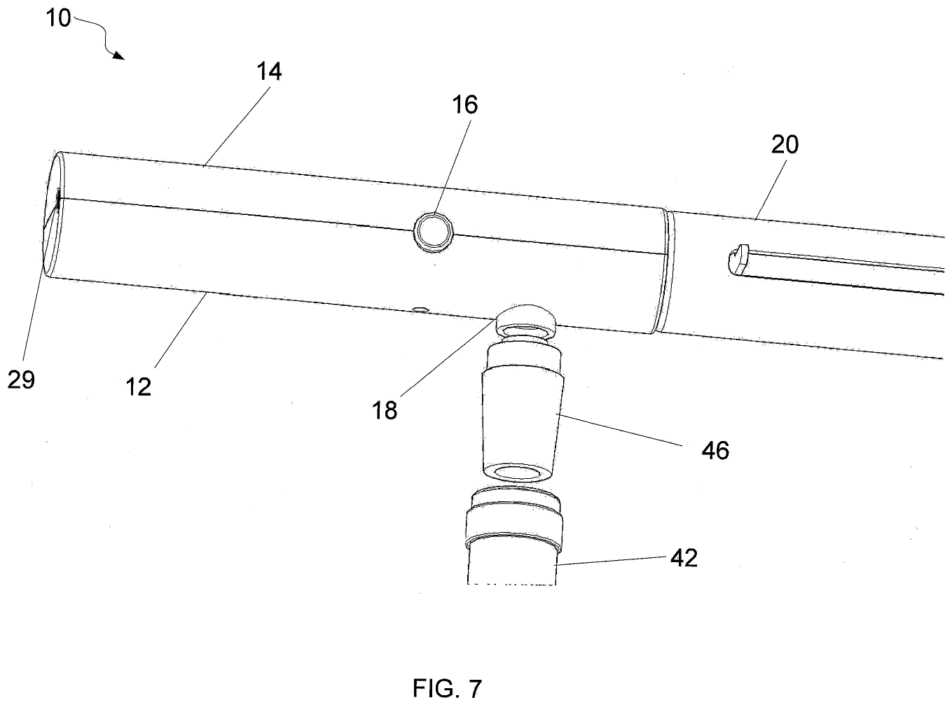

Referring now to FIG. 7, which shows the bottle opening and beverage preservation device 10 being used as a beverage preservation system, whereby air in the bottle 42 is pumped out of the bottle to create a vacuum internally in the bottle. It has been shown that for some beverages, such as for example wine, extended exposure of the wine to oxygen causes the wine to oxidize and spoil. It would therefore be advantageous to remove the air from the bottle to prevent the air from reacting with the remaining beverage in the bottle. A stopper valve 46 is configured to be inserted into the mouth of a bottle 42 such that the stopper valve 46 seals the bottle 42. The stopper valve 46 is also configured to be sealingly inserted into the air inlet 18 that is disposed on a surface of the device 10. The stopper valve 46 is configured to allow air that is internal to the bottle 42 to be drawn out of the bottle 42 when it is in communication with the air inlet 18 thereby creating a vacuum (negative pressure) when the device is turned on internal to the bottle 42. When the stopper valve 46 is removed from the air inlet 18, the vacuum created in the bottle acts to close the stopper valve 46 and prevent air from entering the bottle 42. In this manner, air is drawn out of the bottle 42 by the device 10 thereby substantially reducing the amount of oxygen in the bottle which thereby acts to preserve the beverage still contained in the bottle 42.

What is claimed is:

1. An apparatus for removing a cork/stopper from a bottle, comprising:
an electrically powered motor operatively connected to an air compressor, said air compressor having an air inlet and an air outlet, said air compressor configured to produced pressurized air; and,
an elongated hollow needle having an internal air passageway configured to transfer the pressurized air from said air compressor into the bottle thereby forcing the cork/stopper out of the bottle.

2. The apparatus of claim 1, wherein said air compressor further comprises:
a reciprocating piston configured to sealingly ride in a compressor cylinder;
an inlet check valve adjacent said air inlet configured to allow air to enter said air compressor when said piston is retracting in said compressor cylinder; and,
a needle check valve adjacent said air outlet configured to allow pressurized air to exit said air compressor when said piston is extending in said compressor cylinder.

3. The apparatus of claim 2, wherein said elongated hollow needle is comprised of a non-coring pencil tip that is configured to sealingly pierce through the cork/stopper.

4. The apparatus of claim 1, further comprising a battery in electrical communication with said motor.

5. The apparatus of claim 4, further comprising an electrical switch operatively configured to selectively turn said electrically powered motor off and on by an operator.

6. The apparatus of claim 4, wherein said battery is rechargeable.

7. The apparatus of claim 1, further comprising a guide concentrically located adjacent said elongated hollow needle, said guide being configured to aid an operator while inserting said elongated hollow needle into the bottle.

8. The apparatus of claim 7, further comprising a slide configured to remove the cork/stopper from said needle after the cork/stopper has been removed from the bottle.

9. The apparatus of claim 1, further comprising:
a stopper valve configured to sealingly engage with the bottle, said stopper valve configured to engage with said air inlet, said stopper valve further configured to act as a one way check valve and allow air to be withdrawn from the bottle.

10. A device for removing a cork/stopper from a bottle, comprising:
an electric motor configured to rotate a motor gear;
a piston gear configured to mesh with said motor gear such that said piston gear is powered by said motor;
a piston attached to said piston gear, said piston configured to reciprocate in a back and forth motion as said piston gear rotates;
a compressor cylinder configured to sealingly engage with said piston;
an air inlet disposed on said compressor cylinder;
an air outlet disposed on said compressor cylinder; and,
an elongated hollow needle disposed adjacent said air outlet, said needle being configured to communicate pressurized air into the bottle, thereby forcing the cork/stopper out of the bottle.

11. The device of claim 10, further comprising a battery in electrical communication with said electric motor.

12. The device of claim 11, wherein said battery is rechargeable.

13. The device of claim 12, further comprising a charging circuit in electrical communication with said battery, said charging circuit configured to recharge said battery.

14. The device of claim 11, further comprising an electrical switch disposed on a housing, said electrical switch operatively configured to selectively turn the motor on and off by an operator.

15. The device of claim 10, wherein said needle is comprised of a non-coring pencil tip.

16. The device of claim 10, further comprising a stopper valve configured to sealingly engage with the bottle, said stopper valve configured to engage with said air inlet, said stopper valve further configured to act as a one way check valve and allow air to be withdrawn from the bottle.

17. The device of claim 10, further comprising a cylindrically shaped guide disposed concentrically to said needle, said guide configured to engage around the neck of the bottle in order to help the placement of the needle when said needle is inserted into the cork/stopper.

18. The device of claim 17, further comprising a slide configured to remove the cork/stopper from said needle after the cork/stopper is removed from the bottle.

19. A method for removing a cork/stopper from a bottle comprising the steps of:
inserting an elongated hollow needle past the cork/stopper such that compressed air may be transmitted into the bottle;
attaching an electrically powered air compressor to said needle; and,
activating the electrically powered air compressor to transmit the pressurized air into the bottle such that the cork/stopper is expelled from the bottle.

20. The method of claim 19, further comprising the step of connecting a battery to said electrically powered air compressor.
